(19) United States
(12) Patent Application Publication
(10) Pub. No.: US 2024/0077329 A1
(43) Pub. Date: Mar. 7, 2024

(54) UNDERGROUND WORKSITE MODEL GENERATION

(71) Applicant: SANDVIK MINING AND CONSTRUCTION OY, Tampere (FI)

(72) Inventors: Jussi PUURA, Tampere (FI); Tomi VON ESSEN, Tampere (FI)

(21) Appl. No.: 18/271,706

(22) PCT Filed: Jan. 12, 2021
(86) PCT No.: PCT/EP2021/050438

§ 371 Date: Jul. 11, 2023

(51) Int. Cl. G01C 21/00

(52) U.S. Cl. CPC G01C 21/3848; E21F 13/00

(57) ABSTRACT

A method is provided and includes the steps of detecting a tunnel wall entry for a multi-dimensional worksite model of a worksite, processing at least some of scanning data based on scanning by the scanner by a virtual beam established between the first measurement location and the tunnel wall position, detecting a hit of the virtual beam to a candidate object on the basis of the processing of the at least some of the scanning data, identifying the candidate object to be a dynamic excess object between the position of the scanner and the tunnel wall position on the basis of distance between the candidate intermediate object and the tunnel wall position, and preventing data associated with the identified dynamic excess object to be included in the worksite model applied for controlling autonomous operation of a vehicle in a tunnel of the worksite.

### FIELD

The present invention relates to modelling of underground worksites and in particular to controlling modelling of underground worksite based on environment scanning.

### BACKGROUND

Underground worksites, such as hard rock or soft rock mines, typically comprise a variety of operation zones intended to be accessed by different types of mobile work machines, herein referred to as vehicles. An underground vehicle may be an unmanned, e.g. remotely controlled from a control room, or a manned vehicle, i.e. operated by an operator sitting in a cabin of the vehicle. Vehicles operating in underground work sites may be autonomously operating, i.e. automated or semi-automated vehicles, which in their normal operating mode operate independently without external control but which may be taken under external control at certain operation areas or conditions, such as during states of emergencies. Path planning of such vehicles to drive an optimal path is of importance for operation efficiency. In some systems, an experienced operator may teach an optimal path by driving the vehicle.

WO2015106799 discloses a system for scanning surroundings of a vehicle for producing data to determining position and orientation of the vehicle. The vehicle is provided with a reference point cloud data of the mine. The control unit is configured to match second point cloud data produced by a scanning device of the vehicle to the reference point cloud data in order to determine position data of the vehicle. Changed point cloud objects may be detected and new point cloud data may be incorporated to the reference point cloud data.

A mine may be surveyed repeatedly and in parallel to the normal operational process by vehicles, and a 3D reference model of the mine may thus be updated during production. When modelling the environment, also irrelevant items or objects may be detected, such as a person or temporary equipment at tunnel at the time of scanning.

### SUMMARY

The invention is defined by the features of the independent claims. Some specific embodiments are defined in the dependent claims.

According to a first aspect, there is provided an apparatus, comprising: means for detecting a tunnel wall entry for a multi-dimensional worksite model of a worksite, the tunnel wall entry representing a tunnel wall position defined based on scanning a tunnel wall by a scanner at a first measurement location, means for processing at least some of scanning data based on scanning by the scanner by a virtual beam established between the first measurement location and the tunnel wall position, means for detecting a hit of the virtual beam to a candidate object on the basis of the processing of the at least some of the scanning data, means for identifying the candidate object to be a dynamic excess object between the position of the scanner and the tunnel wall position on the basis of distance between the candidate intermediate object and the tunnel wall position, and means for preventing data associated with the identified dynamic excess object to be included in the worksite model applied for controlling autonomous operation of a vehicle in a tunnel of the worksite. The means may comprise at least one processor and at least one memory including computer program code, the at least one memory and computer program code configured to, with the at least one processor, cause the performance of the apparatus.

According to a second aspect, there is provided a method for path planning for vehicles in underground worksite, comprising: detecting a tunnel wall entry for a multi-dimensional worksite model of a worksite, the tunnel wall entry representing a tunnel wall position defined based on scanning a tunnel wall by a scanner at a first measurement location, processing at least some of scanning data based on scanning by the scanner by a virtual beam established between the first measurement location and the tunnel wall position, detecting a hit of the virtual beam to a candidate object on the basis of the processing of the at least some of the scanning data, identifying the candidate object to be a dynamic excess object between the position of the scanner and the tunnel wall position on the basis of distance between the candidate intermediate object and the tunnel wall position, and preventing data associated with the identified dynamic excess object to be included in the worksite model applied for controlling autonomous operation of a vehicle in a tunnel of the worksite.

According to a third aspect, there is provided an apparatus comprising at least one processor, at least one memory including computer program code, the at least one memory and the computer program code being configured to, with the at least one processor, cause the apparatus at least to carry out the method or an embodiment of the method.

According to a fourth aspect, there is provided a computer program, a computer program product or (a non-tangible) computer-readable medium comprising computer program code for, when executed in a data processing apparatus, to cause the apparatus to perform the method or an embodiment thereof.

According to a fifth aspect, there is provided an underground vehicle, which may comprise a body, a tool, a user interface, and a driveline, wherein the vehicle comprises the apparatus according to the first aspect or any embodiment thereof.

Some further embodiments of any of the aspects are illustrated in the dependent claims and below. It will be appreciated that the embodiments may be applied with any of the aspects and in various combinations.

### BRIEF DESCRIPTION OF THE DRAWINGS

FIG. 1 illustrates an example of an underground worksite;

FIG. 2 illustrates an example of an autonomous mine vehicle;

FIG. 3 illustrates a method according to at least some embodiments;

FIGS. 4a to 4c, and 5 illustrate examples of voxel model processing; and

FIG. 6 illustrate an apparatus capable of supporting at least some embodiments.

### EMBODIMENTS

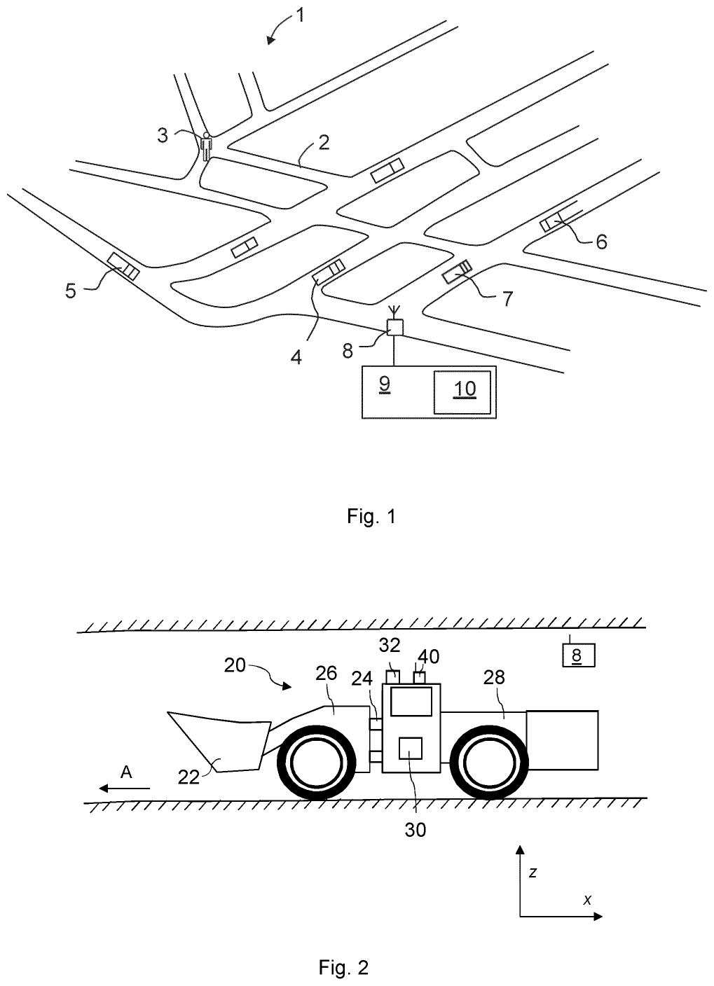

FIG. 1 illustrates an underground worksite 1 comprising a network 2 of underground tunnels. A plurality of mobile objects, such as persons or pedestrians 3 and/or vehicles 4, 5, 6, 7 may be present in and move between different areas or operation zones of the worksite 1.

The term underground worksite herein is intended to include a variety of underground worksites, including for example different kinds of underground excavation worksites, such as mines, roadwork sites, and railroad worksites. The term (mine) vehicle herein refers generally to mobile work machines suitable to be used in the operation of different kinds of underground mining or construction excavation worksites, such as lorries, dumpers, vans, mobile rock drilling or milling rigs, mobile reinforcement machines, and bucket loaders or other kind of mobile work machines which may be used in different kinds of excavation worksites. At least some of the vehicles may be autonomously operating vehicles. The term autonomously operating vehicle herein refers to at least partially automated vehicles. The vehicle may be configured with an autonomous operating mode, during which it may operate/drive independently without requiring continuous user control, but the vehicle may be taken under external control, during states of emergencies, for example.

The worksite 1 comprises a communications system, such as a wireless access system comprising a wireless local area network (WLAN), comprising a plurality of wireless access nodes 8. The access nodes 8 may communicate with wireless communications units comprised by the mine vehicles or mobile devices carried by pedestrians and with further communications devices (not shown), such as network device(s) configured to facilitate communications with a control system 9.

The control system 9 may be an on-site (underground or above-ground) and/or remote via intermediate networks. For example, a server or another control device 10 of the system 9 may be configured to manage at least some operations at the worksite, such as monitor position of vehicles, provide a UI for an operator to remotely monitor and, when needed, control automatic operation operations of the vehicles. The control system 9 or the control device 10 thereof may be arranged to define and assign routes and drive orders for a fleet of vehicles and update and/or monitor drive order performance and status.

The control system 9 may be connected to or via a further network(s) and system(s), such a worksite management system, a cloud service, an intermediate communications network, such as the internet, etc. The system may comprise or be connected to further device(s) or control unit(s), such as a handheld user unit, a vehicle unit, a worksite management device/system, a remote control and/or monitoring device/system, data analytics device/system, sensor system/device, etc.

The worksite 1 may further comprise various other types of mine operations devices connectable to the control system 9 e.g. via the access node 8, not illustrated in FIG. 1. Examples of such further mine operations devices include various devices for power supply, environment sensoring, safety, communications, and other automation devices. For example, the worksite may comprise a passage control system comprising passage control units (PCU) separating operation zones, some of which may be set-up for autonomously operating vehicles. The passage control system and associated PCUs may be configured to allow or prevent movement of one or more vehicles and/or pedestrians between zones.

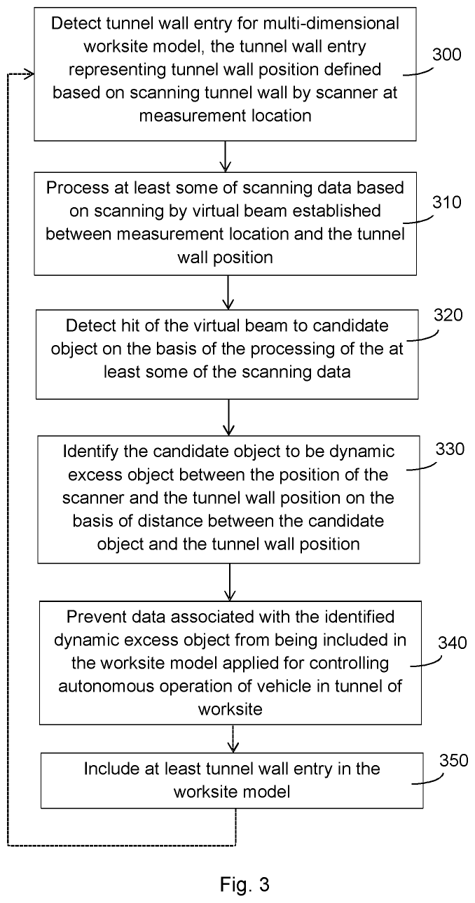

FIG. 2 illustrates a mine vehicle 20, in this example a loader or a load and haul (LHD) vehicle comprising a bucket 22. The vehicle 20 may be an articulated vehicle comprising a front section 26 and a rear section 28 connected by a joint 24. However, it will be appreciated that application of the presently disclosed features for autonomous driving control is not limited to any particular type of vehicle.

The vehicle 20 comprises at least one control unit 30 configured to control at least some functions and/or actuators of the vehicle. The control unit 30 may comprise one or more computing units/processors executing computer program code stored in memory. The control unit may be connected to one or more other control units of a control system of the vehicle, in some embodiments by a controller area network (CAN) bus. For example, the control unit 20 may be connected further actuator control units and/or to a driveline component(s), such as an inverter (control) unit driving an electrical motor or other type of motor control unit. The control unit may comprise or be connected to a user interface with a display device as well as operator input interface for receiving operator commands and information to the control unit.

The control unit 30 may be configured to control at least autonomous operations, and there may be one or more other control units in the vehicle for controlling other operations. It is to be appreciated that the control unit 30 may be configured to perform at least some of the below illustrated features, or a plurality of control units or controllers may be applied to perform these features. There may be further operations, units, modules or functions performed by the control unit(s), e.g. for positioning and/or an obstacle avoidance.

The vehicle 20 may be unmanned. Thus, the user interface may be remote from the vehicle and the vehicle may be remotely controlled by an operator, e.g. in a control room at worksite area or long distance away from the mine via communications network(s). A control unit outside the vehicle 20, for example the control system 9 and the device 10 thereof may be configured to perform at least some of the below illustrated features.

The vehicle 20 may comprise a wireless communication device 40, by which the control unit 20 and/or another unit of control system of the vehicle 20 may establish a data transmission connection to another (second) control system external to the vehicle by utilising a wireless connection provided by a base station or access node 8. The communication device may thus be connected to a communications system of the worksite, such as a wireless access system comprising a wireless local area network (WLAN) and/or a cellular communications network (e.g. a 4G, 5G or another generation cellular network).

The vehicle 20 comprises one or more scanning units, or scanners 32, configured to perform scanning of the environment of the vehicle. For example, the vehicle 20 may comprise a front scanner configured to scan environment towards normal forward driving direction A (and naturally to sides within reach of the scanner). The vehicle may also comprise a rear scanner configured to scan the environment towards direction opposite to A, i.e. backwards of the vehicle. In an example embodiment, the scanner 32 is a 3D scanner, in which case 3D scanning data, e.g. point cloud data, is produced. The scanner 32 may be a laser scanner or another type of sensor device, such as 4D or another type of radar, appropriate for determining obstacles and distances to obstacles for the vehicle.

The scanning results may be applied to detect position and orientation of the vehicle 20 and one or more further elements thereof, such as the scanner 32 or the bucket 22. The control unit 30, or alternatively another control/computation unit in the vehicle, may compare operational scanned tunnel profile data to reference profile data stored in an environment or worksite model. The vehicle may be positioned on the basis of finding a match on the basis of the comparison, thus providing environment scanning based positioning. The environment model may be obtained based on scanning by the vehicle, for example.

The vehicle 20 may be provided with an obstacle detection function or unit, which may be part of a collision avoidance or prevention system and performed by the control unit 30, for example. The obstacle detection function may be configured to perform collision examination based on scanning data received from at least scanner 32.

The vehicle 20 may comprise a simultaneous localization and mapping (SLAM) unit configured to both position the vehicle and map the environment on the basis of (2D or 3D) scanning information from the scanner 32 while the vehicle is driving. The vehicle may be configured to generate or augment a 3D worksite model stored in the vehicle while driving, and/or provide information for generating or augmenting a 3D worksite model stored outside the vehicle, e.g. by the control system 9, and the fleet supervisory device 10 thereof.

A route or drive plan, may be generated based on the worksite model. The route plan may define a route to be driven by the vehicle 20 and may be used as an input for automatic driving of the vehicle. The route plan may be generated offline and off-site, for example in an office, or on-board the vehicle e.g. by a teaching drive. The plan may define a start point and an end point. The route plan may define a set of (intermediate) route points for the automatic drive. Such plan may be sent via a wired or wireless connection to, or otherwise loaded to the vehicle, to a memory of the vehicle for access by the control unit 30 or another unit controlling automatic driving of the vehicle and generating steering parameters or signals to follow the route according to the route plan.

A 3D worksite model of an underground worksite may illustrate at least floor and walls of a tunnel. The 3D worksite model comprises position information in 3D space (such as Cartesian coordinate system xyz coordinate values, in horizontal and vertical planes), but may also comprise further layers (or dimensions) of information. The 3D worksite model may comprise or be generated based on 3D point cloud data, which may be generated on the basis of scanning the tunnel. The worksite model may comprise or be formed based on point cloud data generated on the basis of the scanning. The worksite model may be stored in a database accessible by one or more modules of a computing apparatus, such as a mine model processing module, a user interface or visualizer module, a route planning module, and/or a positioning service module.

Removing of irrelevant objects, such as walking persons or even dust particles, detected during scanning and included in the worksite model may be necessary to guarantee appropriate operation of the autonomous operations, and to avoid unnecessary stopping of the vehicles. However, removing such irrelevant object may require manual work, may be burdensome and may delay starting the autonomous operations at a new worksite portion.

Further improved autonomous operations of vehicles is now facilitated on the basis of improved underground worksite models and model generation. Excess objects may be removed instantly after detecting a tunnel wall position based on scanning, e.g. by the vehicle 20 as illustrated in FIG. 2 when driving at the tunnel and (re-)mapping or (re-)modelling the environment during driving. The worksite model may also be referred to as an environment model or a tunnel model.

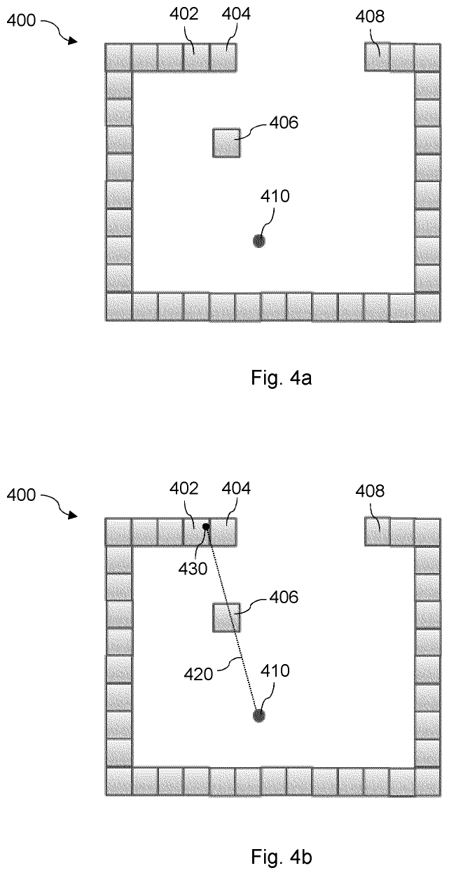

FIG. 3 illustrates a method for processing scanning results and controlling modelling of an underground worksite. The method may be implemented by an apparatus configured for generating a worksite model of an underground worksite, such as a mobile unit, a vehicle on-board control device, or other kind of appropriately configured data processing device. The apparatus may be configured to perform a modelling algorithm which may carry out a modelling control procedure.

The method comprises detecting 300 a tunnel wall entry for a multi-dimensional worksite model, the tunnel wall entry representing a tunnel wall position defined on the basis of scanning a tunnel wall by a scanner at a (first) measurement location, such as the scanner 32 of the vehicle 20.

At least some of scanning data based on scanning by the scanner is processed 310 by a virtual beam established between the measurement location (of the scanner) and the tunnel wall position. The tunnel wall entry may have been identified based on processing (first) scanning data (of a first scanning event). The scanning data processed in block 310 may be (second) scanning data (of a second scanning event), at least partially different than the (first) scanning data applied for identifying the tunnel wall entry. At least some of the (second) scanning data may be processed to detect if there are any intermediate objects between the measurement location and the tunnel wall position. Block 320 comprises detecting a hit of the virtual beam to a candidate object on the basis of the processing of the scanning data.

Block 330 comprises determining the candidate object to be a dynamic intermediate excess object between the position of the scanner and the tunnel wall position on the basis of distance between the candidate intermediate object and the tunnel wall position. There may be one or more (intermediate) steps of assessing or evaluating the candidate object, which may result to the candidate object either being identified as the dynamic excess object or identifying the candidate object as object to be maintained in the resulting worksite model.

Block 340 comprises preventing data associated with the identified dynamic excess object to be included in the worksite model applied for controlling autonomous operation of a vehicle in a tunnel of the worksite. This may comprise removing or otherwise excluding data associated with the identified intermediate excess object from a data set that will be used to generate or update the worksite model.

Thus, data representative of the identified intermediate excess object may be prevented from being part of the tunnel model being generated. This data may be removed from a data set to be used for the worksite model, after further processing or directly stored into the worksite model, whereas remaining data, such as the tunnel wall entry is being used for the model.

The scanning data being processed may refer to a sub-set of scanning data that has been received from the scanner (e.g. scanner 32 of vehicle 20) or from a data processing module or unit that has (pre)processed data from the scanner. The scanning data being processed is indicative of scanning results, and may refer to data representation format into which detected measurement points have been converted or mapped, and may be referred to e.g. intermediary or pre-worksite model data. For example, a voxel map, an occupancy map, or a mesh map in world coordinate system is established based on 3D coordinates detected based on the scanning and then further processed in blocks 310 to 340.

The tunnel wall entry may refer to a measurement point detected based processing scanning data, which may be further updated based on further measurements and then again processed. It is to be noted that the tunnel wall entry is to be understood broadly, and may comprise measurement information and point(s) of any static object detected based on the scanning. Sometimes this may comprise static objects not forming part of, but being in proximity of, a rock tunnel wall structure. For example, a tunnel wall entry may comprise one or more measurement points based on a container relying next to a tunnel wall. Processing 310 the scanning data by the virtual beam in block 310 may refer to computationally processing tunnel model data representative of a path between measurement location and the tunnel wall position, in an example embodiment associated intermediate voxel entries of voxel model based on the scanning. This may comprise (identifying and) computing distance to closest object from the measurement location (coordinate point) towards the tunnel wall (coordinate point), e.g. by ray-casting.

Detecting 320 the hit of the virtual beam to a candidate intermediate dynamic object may refer to computationally defining if an object (or obstacle) is detected between the measurement location and the tunnel wall position. This may comprise detecting the virtual beam intersecting the dynamic object, and/or identifying that the distance from the measurement location to the position of the candidate dynamic object differs from distance between the measurement location and the tunnel wall. There are various options for implementing the identification 330 (directly or indirectly) based on the distance, e.g. in a simple example the distance is compared to an associated (minimum distance) threshold value, and if the threshold value is exceeded, the candidate object is identified as dynamic excess object.

Block 300 may be entered after the tunnel wall position has been identified (based on identifying a hit point based on processing scanning data at a first measurement/scanning (event) at the first measurement location), after receiving scanning data on further measurement(s) associated with the first measurement location.

Block 300 or 310 may be entered and an already generated and stored tunnel wall entry may be obtained instantly in response to performing a further (second measurement/scanning (event)) at/assigned to the first measurement location by the scanner moving in the tunnel, e.g. by the vehicle 20 which may be thus autonomously operating in the tunnel. Thus, even though the scanner position would be slightly different at the subsequent second measurement, the measurements may be associated with the same first measurement location. A distance threshold may be preconfigured, and processing steps to identify dynamic objects (e.g. blocks 300 to 304) are performed in response to detecting that movement of the scanner 32 (or another reference) point of the vehicle) since preceding processing steps to identify dynamic objects exceeds the distance threshold. For example, the distance threshold value may be selected from a range of 1 to 30 cm, in a further example 5 to 15 cm, such as 10 cm. The scanner 30 may perform multiple measurements at/assigned to the first measurement location. For example, the scanner may be configured to perform several or tens of measurements per second, such as 10 measurements per second. It is to be noted that the time differences between these multiple measurements may vary substantially; the vehicle may perform the multiple measurements with very short time difference when at the measurement location and/or with subsequent measurement(s) with substantially larger time difference when returning to the measurement location. It is also to be noted that at least some of the features illustrated in connection with FIG. 3 may be applied with a (non-SLAM type) mapping procedure, which may generate/update the tunnel model based on multiple independent scannings (within the tunnel model scope). Once appropriate transformation matrix(ces) (to global/worksite coordinate system) is(are) defined, entries based on such scannings (and after removal of identified dynamic excess objects) may be added into the tunnel model.

The tunnel wall entries, and other entries based on tunnel scanning, such as an entry indicative of the candidate object, may be associated with, or include timing or timestamp information indicative of respective time of measurement/scanning. Such timing information may be applied in block 330, in an embodiment time stamp of the tunnel wall position (scanning) and time stamp of candidate object (scanning) are compared.

As further illustrated in FIG. 3, the method may further comprise including 350 at least the tunnel wall entry in the worksite model after block 340. Block 300 may be returned to detecting a subsequent tunnel wall position on the basis of processing scanning data based on scanning by the scanner at a subsequent/second measurement location. This may be performed after including the tunnel wall entry detected based on the first measurement location into the worksite model, or data related to a set of tunnel wall entries based on repeating blocks 300 to 340 may be stored at a time into the worksite model. It is to be noted that a set of tunnel wall entries may be processed at a time.

The tunnel wall entry may thus be detected and excess intermediate objects removed before adding the tunnel wall entry to the worksite model, enabling reduced processing resources and time. Tunnel wall position entries or records may be added into the worksite model in measurement time order after the coordinates of the tunnel wall position are determined (e.g. in block 300) and related excess object(s) removed.

The data set used for generating the tunnel model may hence be instantly and automatically computationally ‘cleaned’ from dynamic excess objects when scanning the environment by the vehicle 20. The worksite model does not have to be after-processed. The worksite model may be instantly used for autonomous operations of the vehicle (or another vehicle), such as positioning the vehicle, vehicle path planning, and/or analyzing drivability along the tunnel for the vehicle. The vehicle may be controlled in various ways based on the tunnel model. For example, speed of the vehicle and/or steering actions are controlled based on the tunnel model. Some further example embodiments are illustrated below.

The method may further comprise one or more processing steps and filtering or exclusion conditions for the candidate objects, before or as part of block 330, to avoid removing wall or other relevant and non-dynamic object from the data set used to be used for the worksite model. Such filtering conditions and avoidance of removal of a candidate object detected in block 320 may be based on proximity of the candidate object to other detected objects and/or time information dependent on time of measurement of the candidate object. By applying such features, in certain situations, such as when orientation of scanner measurement is close to tunnel wall line, removal of e.g. protruding parts of wall may be avoided and better-quality worksite model achieved.

A distance indicator dependent on distance between the candidate object and the tunnel wall position may be generated as part of block 320 or as an additional block between blocks 320 and 330. The candidate object may be identified 330 as the dynamic excess object in response to the distance of the indicator exceeding a minimum distance threshold value.

A set of candidate (excess) objects may be detected in block 320. Thus, a plurality of hits of the virtual beam may be detected between the position of the scanner 32 and the tunnel wall position. For a candidate object in the set, distance(s) to at least one closest other object is determined. The closest other object may be a candidate object in the set or the tunnel wall position. The candidate object may be identified as the intermediate dynamic excess object on the basis of the distance to such successive/neighbouring object. If the distance exceeds a threshold value, the candidate object may be identified 330 as the dynamic excess object and associated data may be removed in block 340. If the distance does not exceed the threshold value, the candidate object and associated data may be maintained (and subsequently included in the worksite model). This enables to avoid removing objects close to the tunnel wall position hit by the virtual beam.

Various implementation options and map or model formats exist for generating the worksite model, such as mesh, occupancy, or voxel models. Some further example embodiments are illustrated below, in which voxel-based modelling and processing is applied, without however limitation to this representation format. The tunnel wall entry may be a voxel entry (or record) of a voxel map comprising a set of voxel entries, generated on the basis of the processing of the scanning data. An area being mapped may be divided into voxels of predefined size. For computational and storage efficiency, only those voxels may be maintained in which a scanner measurement (hit) is detected. Such voxel entry may be indicative of 3D coordinates xyz of the tunnel wall position (which may be defined in world coordinate system).

In an example embodiment, a voxel entry may further comprise at least some of:
Timestamp indicative of time of the scanner measurement; timestamp,
Number of times a (tunnel wall) measurement point is detected or hit by scanner measurement in the respective voxel; NumDetects,
Number of times a virtual beam between the scanner measurement location and a measurement point has hit or at least partially intersected a respective voxel being examiner; NurnIntersectedRays.

Conversion from scanner coordinate system to world coordinate system may be obtained by a mapping algorithm mapping new measurement point(s) (in scanner coordinate system) to points included in voxels and in world coordinate system. When the mapping is performed, the detected measurement point(s) in the scanner coordinate system are converted into world coordinate system coordinates and a voxel map update process may be performed to update the voxel map with new measurement point(s). An occupancy map may be generated based on the voxel entry information.

A first phase of the voxel map update process may comprise checking if a voxel in which a new (tunnel wall) measurement point is detected is already existing or reserved.
If the voxel is not reserved, it may be marked as reserved and added into the voxel map. A counter NumDetects may be established for the voxel and initialized to have value one and a counter NurnIntersectedRays for the voxel may be initialized to have value zero.
If the voxel is already reserved, value of counter NumDetects may be increased by one. Other voxel information is maintained.

A second phase of the voxel map update process may comprise identifying and removing dynamic excess objects, in the present example such voxels, at measurement location of the scanner being examined. This is based on the method of FIG. 3, and the assumption that objects intersected or cut by the beam cannot be existing in the real world or map. The second phase may comprise a) to g) below:
a) Establishing a virtual beam (block 310) between (the examined) scanner coordinates and the measurement point coordinates (in world coordinate system).
b) Detecting any (candidate object representing) voxels hit or intersected by the virtual beam (block 320), thus forming a set of (candidate object) voxels.
c) Increasing respective counters NumIntersectedRays of such detected voxels of the set by one.
d) Arranging the detected voxels of the set into distance order based on distance of each voxel from the measurement point (based on mid-points of respective voxels). The voxels may be arranged into increasing distance order Vₙ, Vₙ₋₁, . . . , V₁, wherein Vₙ is a voxel (of the detected voxels) closest to the measurement point and V₁ is a voxel closest to the scanner (first measurement) location.
e) Processing the ordered voxels. This may be performed starting from the voxel V n closest to the measurement point and may comprise comparing distances of the successive or neighbouring voxels in the set.
f) Checking first condition for removing a voxel being examined in the set. This may comprise allowing removal of a voxel in the set if the distance of the voxel (mid-point/centroid) to a closest other detected voxel (mid-point/centroid) in the set exceeds a threshold value, which may be defined by parameter DistanceThreshold. For example, distance between mid-points of Vₙ, and Vₙ₋₁, d=∥Vₙ−Vₙ₋₁∥, wherein ∥·∥ denotes Euclidean L2 norm, needs to exceed DistanceThreshold, i.e. d>DistanceThreshold.
g) Checking second or further condition(s) for removal for voxels (remaining as candidate excess voxels in the set) that satisfy the first condition. This may comprise checking if value of counter NumIntersectedRays exceeds an associated condition or counter threshold value. For example, the condition may be based on number of measurement point detections for the voxel and include requiring NumIntersectedRays>n*NumDetects, wherein n is a scalar multiplier. Another condition, which may be required, may comprise comparing time stamps of the remaining voxels in the set to time stamp of the voxel of the measurement point: If the time stamps are equal, the voxel in the set is not removed, but if they differ, the voxel may be removed. This enables to avoid removing voxels in which measurement points hit.

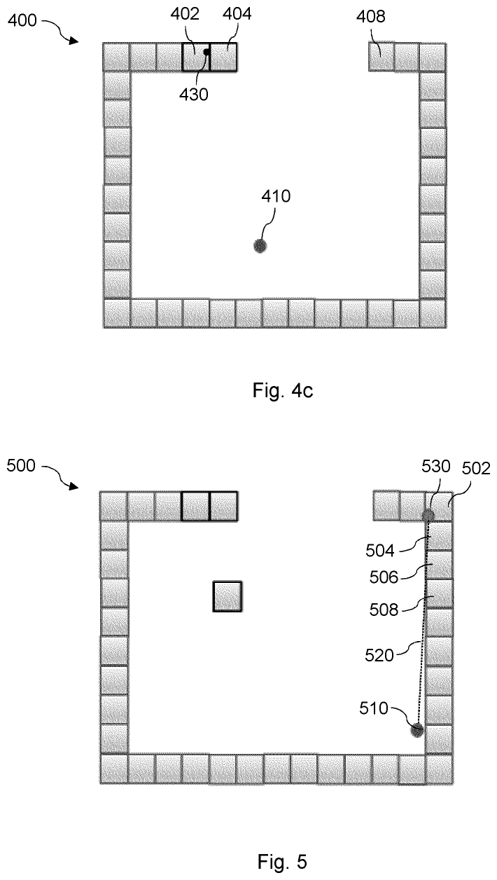

Reference is made to the simple example of FIG. 4a illustrating a voxel map 400 of voxels 402, 404, 406, 408 and a scanner position 410 in the map.

A set of voxel entries may be detected to include a new measurement point or tunnel wall point into the worksite model. For example, as further illustrated in FIG. 4b, voxels 402 to 406 may illustrate voxel entries hit by virtual beam 420 from the scanner position 410. New measurement point 430 may be detected (as the tunnel wall position) in voxel 402. Based on applying the method of FIG. 3, voxel 406 may be identified 330 as dynamic excess object, and associated data removed before including data on the measurement/tunnel wall point 430 in the worksite model. However, voxel 404 is detected not to qualify as dynamic excess object. This may be detected in response to distance of voxel 404 to the measurement point 430 not exceeding a (minimum distance) threshold value. Voxel 404 may in a subsequent scanning measurement location be detected to include a tunnel wall position. FIG. 4c illustrates the voxel map after removal of the voxel 406.

FIG. 5 illustrates another example of a voxel map 500, in which the scanner position 510 is such that the virtual beam 520 to a new measurement point 530 in voxel 502 hits or detects three other voxels 504, 506, and 508. When applying the distance threshold, e.g. as illustrated above as the first condition, removal of the voxels 504 to 508 may be avoided.

The 3D worksite model generated based repeating the method of FIG. 3 may be applied for one or more of controlling positioning, obstacle detection and avoidance, drivability analysis, path planning, or autonomous steering control of the vehicle, excavation quality analysis, or concrete thickness analysis. In such applications it is very important that the analytics is not hindered by false objects in the model. For example, a person in the model should not be analyzed as an obstacle or road condition problem.

In an example embodiment, the worksite model is used for drivability analysis. Drivability data indicative of drivability of a vehicle at a set of locations in the tunnel may be generated on the basis of worksite model and the included tunnel wall/measurement points thereof. A drivability map or model may be generated, in which such drivability data is included. Path may be computationally planned for the vehicle, off-line or during driving, based on the drivability analysis or the resulting drivability data/map.

The drivability data may be vehicle specific drivability data, specific to an automated or semi-automated vehicle or vehicle type. The path and/or the drivability data may be generated based on vehicle property data indicative of at least dimensions of the vehicle of the type of the vehicle. Appropriate vehicle property data may be retrieved from a memory or another device on the basis of vehicle or vehicle type identifier received for drivability map generation and/or path planning. For example, load&haul devices of a given series or product family may have particular common dimensions, which are indicated in associated vehicle property data and used to generate the drivability data and/or the path information for these vehicles. The drivability map may indicate points in the sub-set of points of the worksite model traversable by the vehicle or the vehicle type. For example, the drivability map may comprise a sub-set of points, such as floor points indicative of floor of the tunnel in the model, drivable by the vehicle or vehicle type, or an indication of drivability (drivable or non-drivable) for a vehicle or vehicle type is included in at least some points of the drivability map.

In an example embodiment, tunnel height is included in the drivability data or used for generating the drivability data. The tunnel height may be defined on the basis of the 3D worksite model, e.g. by ray-casting operation upwards of a floor point being assessed. Drivability data may be generated for the first point on the basis of the determined tunnel height at a measurement point. In some embodiments, the tunnel height is compared to a minimum tunnel height threshold value, which may be vehicle specific. An indication of the tunnel height and/or an indication of non-drivability may be included in the drivability map for the first point in response to the tunnel height not exceeding the minimum tunnel height threshold.

In another example embodiment, vehicle speed and/or energy consumption information is defined on the basis of the drivability analysis and included in the drivability data or used for generating the drivability data. At least some of the above illustrated information, such as the battery consumption, on the drivability map can also be transmitted and visualized for an operator, such as in control room products.

It is to be noted that the 3D worksite model may be repetitively updated by vehicles operating at the worksite when carrying out dedicated normal operations of the vehicle. For example, a drill rig or a load&haul vehicle may be operate as a mobile surveying device and be configured to scan their operating area in the tunnel at every round to update the model with the excavation progress. In some embodiments, the update of the (mine) 3D model triggers automatic update of the floor model and possible further associated models, such as a surface mesh model, to match the updated model. Hence, also the sub-set of points of the worksite model, and the drivability map, may be updated in response to detecting update of the 3D model. The 3D model and the resulting drivability data of the worksite may thus be accurate and updated continuously.

An electronic device comprising electronic circuitries may be an apparatus for realizing at least some embodiments of the present invention. The apparatus may be comprised in at least one computing device connected to or integrated into a control system which may be part of a vehicle.

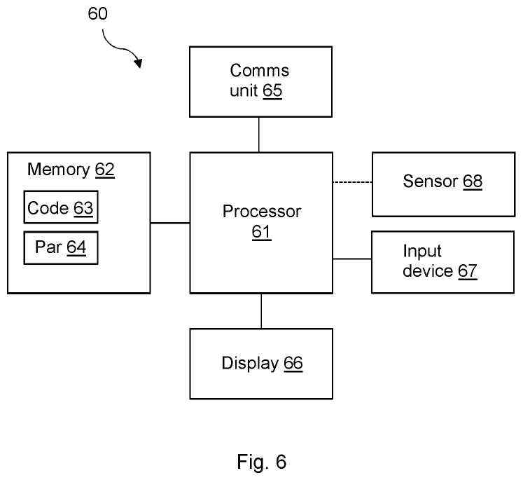

FIG. 6 illustrates an example apparatus capable of supporting at least some embodiments of the present invention. Illustrated is a device 60, which may be configured to carry out at least some of the embodiments relating to the processing of the scanning data and selectively generating data into the worksite model, as illustrated above. In an embodiment, the device is comprised by the vehicle 4-7, 20, such as a vehicle control unit 30, configured to perform at least some of the above embodiments.

Comprised in the device 60 is a processor 61, which may comprise, for example, a single- or multi-core processor. The processor 61 may comprise more than one processor. The processor may comprise at least one application-specific integrated circuit, ASIC. The processor may comprise at least one field-programmable gate array, FPGA. The processor may be configured, at least in part by computer instructions, to perform actions.

The device 60 may comprise memory 62. The memory may comprise random-access memory and/or permanent memory. The memory may be at least in part accessible to the processor 61. The memory may be at least in part comprised in the processor 61. The memory may be at least in part external to the device 60 but accessible to the device. The memory 62 may be means for storing information, such as parameters 64 affecting operations of the device. The parameter information in particular may comprise parameter information affecting e.g. at least some of the operations of blocks 300 to 350, such as threshold values.

The memory 62 may comprise computer program code 63 including computer instructions that the processor 61 is configured to execute. When computer instructions configured to cause the processor to perform certain actions are stored in the memory, and the device in overall is configured to run under the direction of the processor using computer instructions from the memory, the processor and/or its at least one processing core may be considered to be configured to perform said certain actions. The processor may, together with the memory and computer program code, form means for performing at least some of the above-illustrated method steps in the device.

The device 60 may comprise a communications unit 65 comprising a transmitter and/or a receiver. The transmitter and the receiver may be configured to transmit and receive, respectively, information in accordance with at least one cellular or non-cellular standard. The transmitter and/or receiver may be configured to operate in accordance with global system for mobile communication, GSM, wideband code division multiple access, WCDMA, long term evolution, LTE, 3GPP new radio access technology (N-RAT), wireless local area network, WLAN, and/or Ethernet standards, for example. The device 60 may comprise a near-field communication, NFC, transceiver. The NFC transceiver may support at least one NFC technology, such as NFC, Bluetooth, or similar technologies.

The device 60 may comprise or be connected to a UI. The UI may comprise at least one of a display 66, a speaker, an input device 67 such as a keyboard, a joystick, a touchscreen, and/or a microphone. The UI may be configured to display views on the basis of the drivability map and/or associated path information. A user may operate the device and control at least some features of a control system, such as the system illustrated in FIG. 6. In some embodiments, the user may control a vehicle 4-7, 20 and/or the control device 10 via the UI, for example to change operation mode, change display views, modify parameters 64 in response to user authentication and adequate rights associated with the user, etc.

The device 60 may further comprise and/or be connected to further units, devices and systems, such as one or more sensor devices 68 sensing environment of the device 60 and/or movement of the vehicle, such as the scanner 32.

The processor 61, the memory 62, the communications unit 65 and the UI may be interconnected by electrical leads internal to the device 60 in a multitude of different ways. For example, each of the aforementioned devices may be separately connected to a master bus internal to the device, to allow for the devices to exchange information. However, as the skilled person will appreciate, this is only one example and depending on the embodiment various ways of interconnecting at least two of the aforementioned devices may be selected without departing from the scope of the present invention.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Various described features, structures, or characteristics may be combined in any suitable manner in one or more embodiments. While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, i.e. a singular form, throughout this document does not exclude a plurality.

1. An apparatus, comprising:
means for detecting a tunnel wall entry for a multi-dimensional worksite model of a worksite, the tunnel wall entry representing a tunnel wall position defined based on scanning a tunnel wall by a scanner at a first measurement location;
means for processing at least some of scanning data based on scanning by the scanner by a virtual beam established between the first measurement location and the tunnel wall position;
means for detecting a hit of the virtual beam to a candidate object on the basis of the processing of the at least some of the scanning data;
means for identifying the candidate object to be a dynamic excess object between the position of the scanner and the tunnel wall position on the basis of distance between the candidate intermediate object and the tunnel wall position; and
means for preventing data associated with the identified dynamic excess object to be included in the worksite model applied for controlling autonomous operation of a vehicle in a tunnel of the worksite.

2. The apparatus of claim 1, further comprising means for including at least the tunnel wall entry into the worksite model after removing the data associated with the identified dynamic excess object, the apparatus being configured to return to detecting a subsequent tunnel wall position on the basis of processing scanning data based on scanning by the scanner at a second measurement location.

3. The apparatus of claim 1, wherein the apparatus is configured to define the tunnel wall position based on a first measurement associated with the first measurement location, the apparatus being configured to perform the processing of the at least some of the scanning data by the virtual beam during driving of the vehicle and in response to a second measurement associated with the first measurement location by the scanner at the vehicle operating in the tunnel.

4. The apparatus of claim 1, wherein the apparatus is configured to detect a set of objects on the basis of detecting hits of the virtual beam between the position of the scanner and the tunnel wall position, determine distances between objects of the set, and identify the candidate object as the intermediate excess object on the basis of a distance of the candidate object to a closest other object in the set exceeding a threshold value.

5. The apparatus of claim 1, wherein the tunnel wall entry is a tunnel wall voxel entry of a voxel map having a set of voxel entries generated on the basis of the processing scanning data from the scanner, wherein the tunnel wall voxel entry is indicative of three-dimensional coordinates of the tunnel wall position.

6. The apparatus of claim 5, wherein the tunnel wall voxel entry is indicative of number of hits representing number of tunnel wall point detections, and the number of hits is increased in response to detecting the tunnel wall position.

7. The apparatus of claim 5, wherein the candidate object is represented by a candidate object voxel entry in the set of voxel entries and indicative of number of intersected rays representing number of hits in the candidate object voxel based on the virtual beam between a voxel entry comprising the position of the scanner and the tunnel wall voxel entry comprising the tunnel wall position.

8. The apparatus of claim 5, wherein the voxel entries include time stamp information indicative of time of measurement.

9. The apparatus of claim 8, wherein the candidate object is identified to be a dynamic excess object and data associated with the candidate object is removed in response to a time stamp of a voxel of the candidate object differing from a time stamp of the voxel entry of tunnel wall position.

10. The apparatus of claim 1, wherein the tunnel model is a drivability map or the apparatus is configured to generate a drivability map or analyse drivability on the basis of the worksite model including the tunnel wall entry.

11. The apparatus of claim 1, further comprising a simultaneous localization and mapping module configured to process the scanning data and remove the data associated with the identified dynamic excess object as the vehicle autonomously drives in the tunnel.

12. An underground vehicle, comprising the apparatus of claim 1.

13. A method for controlling modelling of underground environment, the method comprising:
detecting a tunnel wall entry for a multi-dimensional worksite model of a worksite, the tunnel wall entry representing a tunnel wall position defined based on scanning a tunnel wall by a scanner at a first measurement location;
processing at least some of scanning data based on scanning by the scanner by a virtual beam established between the first measurement location and the tunnel wall position;
detecting a hit of the virtual beam to a candidate object on the basis of the processing of the at least some of the scanning data;
identifying the candidate object to be a dynamic excess object between the position of the scanner and the tunnel wall position on the basis of distance between the candidate intermediate object and the tunnel wall position; and
preventing data associated with the identified dynamic excess object to be included in the worksite model applied for controlling autonomous operation of a vehicle in a tunnel of the worksite.

14. The method of claim 13, further comprising including at least the tunnel wall entry into the worksite model after removing the data associated with the identified dynamic excess object, and returning to detecting a subsequent tunnel wall position on the basis of processing scanning data based on scanning by the scanner at a second measurement location.

15. The method of claim 13, wherein the tunnel wall position is defined based on a first measurement associated with the first measurement location and the processing of the at least some of the scanning data by the virtual beam is performed during driving of the vehicle and in response to a second measurement associated with the first measurement location by the scanner at the vehicle operating in the tunnel.

16. The method of claim 13, further comprising detecting a set of objects on the basis of detecting hits of the virtual beam between the position of the scanner and the tunnel wall position, determining distances between objects of the set, and identifying the candidate object as the intermediate excess object on the basis of a distance of the candidate object to a closest other object in the set exceeding a threshold value.

17. The method of claim 13, wherein the tunnel wall entry is a tunnel wall voxel entry of a voxel map including a set of voxel entries generated on the basis of the processing scanning data from the scanner, wherein the tunnel wall voxel entry is indicative of three-dimensional coordinates of the tunnel wall position.

18. The method of claim 17, wherein the tunnel wall voxel entry is indicative of number of hits representing number of tunnel wall point detections, and the number of hits is increased in response to detecting the tunnel wall position.

19. The method of claim 17, wherein the candidate object is represented by a candidate object voxel entry in the set of voxel entries and indicative of number of intersected rays representing number of hits in the candidate object voxel based on the virtual beam between a voxel entry comprising the position of the scanner and the tunnel wall voxel entry including the tunnel wall position.

20. The method of claim 17, wherein the voxel entries include time stamp information indicative of time of measurement.

21. The method of claim 20, wherein the candidate object is identified to be a dynamic excess object and data associated with the candidate object is removed in response to a time stamp of a voxel of the candidate object differing from a time stamp of the voxel entry of tunnel wall position.

22. The method of claim 13, wherein the tunnel model is a drivability map or the apparatus is configured to generate a drivability map or analyse drivability on the basis of the worksite model including the tunnel wall entry.

23. The method of claim 13, wherein a simultaneous localization and mapping module in the vehicle processes the scanning data and removes the data associated with the identified dynamic excess object as the vehicle autonomously drives in the tunnel.

24. A computer program comprising code for, when executed in a data processing apparatus, causes a method in accordance with claim 13 to be performed.
